(19) United States
(12) Patent Application Publication
(10) Pub. No.: US 2025/0141128 A1
(43) Pub. Date: May 1, 2025

(54) TERMINAL BLOCK

(71) Applicant: YAZAKI CORPORATION, Tokyo (JP)

(72) Inventors: Wataru Hasegawa, Makinohara-shi (JP); Yasuhiro Tanaka, Makinohara-shi (JP)

(21) Appl. No.: 18/927,792

(22) Filed: Oct. 25, 2024

(30) Foreign Application Priority Data
Nov. 1, 2023 (JP) 2023-187449

(51) Int. Cl. H01R 9/16

(52) U.S. Cl. CPC H01R 9/16

(57) ABSTRACT

A housing including a fitting portion that is inserted into and fitted into a through-hole-shaped fitting hole of a wall body of an object to be assembled from a distal end 11a and allows the distal end to protrude from one wall surface of the wall body at a fitting completion position with respect to the fitting hole, an electrical connection member housed in the housing and responsible for electrical connection with a counterpart, and a holding member that holds the housing on the wall body at the fitting completion position are provided, and the holding member is fitted into a groove of the distal end of the fitting portion at the fitting completion position and is locked to the one wall surface of the wall body in a fitted state to hold the housing at the fitting completion position on the wall body.

### CROSS-REFERENCE TO RELATED APPLICATION(S)

The present application claims priority to and incorporates by reference the entire contents of Japanese Patent Application No. 2023-187449 filed in Japan on Nov. 1, 2023.

### BACKGROUND OF THE INVENTION

### 1. Field of the Invention

The present invention relates to a terminal block.

### 2. Description of the Related Art

Conventionally, a terminal block is assembled to an object to be assembled by inserting and fitting a tubular fitting portion of a housing into a fitting hole of a wall body of the object to be assembled and screwing a flange of the housing to the wall body, for example. This type of terminal block is disclosed, for example, in Japanese Patent Application Laid-open No. 2022-066811 and Japanese Patent Application Laid-open No. 2023-043777.

By the way, the conventional terminal block adopts a screwing structure with respect to the wall body of the object to be assembled, work of fastening a screw member is required, and the work requires manpower.

### SUMMARY OF THE INVENTION

Therefore, an object of the present invention is to provide a terminal block capable of reducing an assembling work time.

In order to achieve the above mentioned object, a terminal block according to one aspect of the present invention includes a housing including a fitting portion that is inserted and fitted into a fitting hole having a through-hole shape of a wall body of an object to be assembled from a distal end and allows the distal end to protrude from one wall surface of the wall body at a fitting completion position with respect to the fitting hole; an electrical connection member housed in the housing and responsible for electrical connection with a counterpart; and a holding member that holds the housing on the wall body at the fitting completion position, wherein the holding member is fitted into a groove at the distal end of the fitting portion at the fitting completion position and is locked to the one wall surface of the wall body in a fitted state to hold the housing at the fitting completion position on the wall body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a terminal block according to an embodiment;

FIG. 2 is a perspective view illustrating the terminal block according to the embodiment; and

FIG. 3 is a cross-sectional view taken along a line X-X of FIG. 2.

### DETAILED DESCRIPTION OF THE PREFERRED EMBODIMENTS

Hereinafter, embodiments of a terminal block according to the present invention will be described in detail with reference to the drawings. Incidentally, the invention is not limited by the embodiments.

### Embodiment

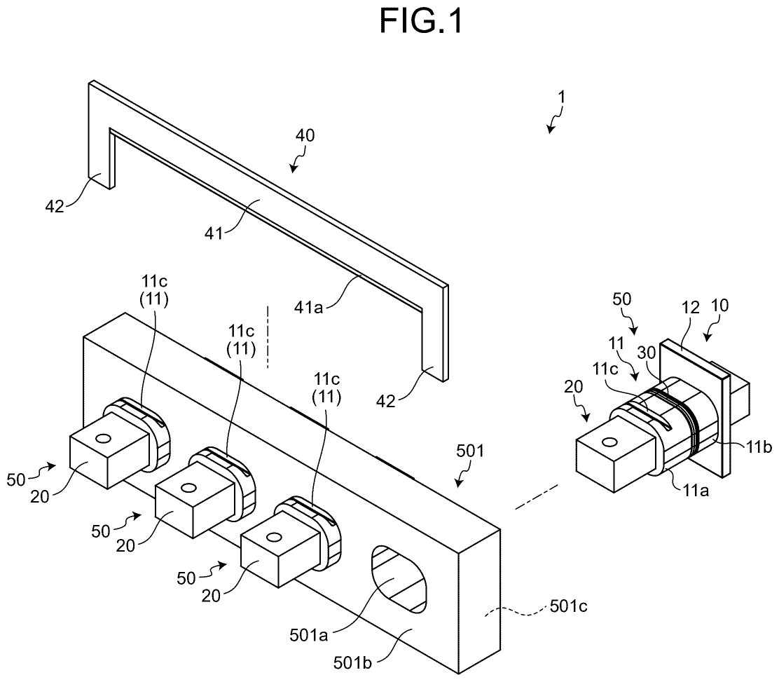

One of the embodiments of the terminal block according to the present invention will be described with reference to FIGS. 1 to 3.

Reference numeral 1 in FIGS. 1 to 3 represents a terminal block according to the present embodiment. The terminal block 1 is assembled to, for example, a wall body 501 of a casing of an object to be assembled (for example, an inverter or the like) to electrically connect a main body (for example, an inverter main body or the like) inside the casing to an external electric device (for example, a motor or the like) (FIGS. 1 to 3). For example, the casing is molded using a metal material.

The terminal block 1 includes a housing 10 assembled and fixed to the wall body 501 of the casing (FIGS. 1 to 3). The housing 10 is molded using an insulating material such as synthetic resin.

The housing 10 includes a fitting portion 11 that is inserted and fitted into a through-hole-shaped fitting hole 501a of the wall body 501 from a distal end 11a, and a flange 12 provided at a rear end 11b of the fitting portion 11 (FIGS. 1 to 3). The fitting hole 501a is a through-hole that allows one wall surface 501b side and the other wall surface 501c side of the wall body 501 to communicate with each other (FIG. 1).

The fitting portion 11 is formed such that an outer peripheral edge shape of a cross section orthogonal to an insertion direction into the fitting hole 501a is similar to the fitting hole 501a. Then, the fitting portion 11 causes the distal end 11a to protrude from the one wall surface 501b of the wall body 501 at a fitting completion position with respect to the fitting hole 501a (FIGS. 1 to 3). Meanwhile, the flange 12 is locked to the other wall surface 501c of the wall body 501 at the fitting completion position (FIG. 3).

The terminal block 1 includes an electrical connection member 20 housed in the housing 10 and responsible for electrical connection with a counterpart (FIGS. 1 to 3). The electrical connection member 20 is molded using a conductive material such as metal. The electrical connection member 20 is housed in the fitting portion 11, and has one end portion protruding from the distal end 11a of the fitting portion 11 and the other end portion protruding from the rear end 11b of the fitting portion 11 (FIGS. 1 and 3). One of the end portions of the electrical connection member 20 is electrically connected to the main body (for example, the inverter main body or the like) inside the casing, and the other end portion is electrically connected to the external electric device (for example, the motor or the like).

In the terminal block 1 illustrated here, the housing 10 is insert-molded with respect to the electrical connection member 20 installed in a mold, whereby the electrical connection member 20 is housed in the fitting portion 11.

At the fitting completion position of the fitting portion 11 and the fitting hole 501a, an annular gap is formed between an outer peripheral surface of the fitting portion 11 and an inner peripheral surface of the fitting hole 501a at the fitting completion position. The terminal block 1 is provided with an annular seal member (so-called O-ring) 30 that closes the annular gap (FIGS. 1 and 3). The seal member 30 is fitted into an annular groove formed on the outer peripheral surface of the fitting portion 11.

The terminal block 1 includes a holding member 40 that causes the wall body 501 to hold the housing 10 at the fitting completion position (FIGS. 1 to 3). The holding member 40 is fitted into a groove 11c of the distal end 11a of the fitting portion 11 at the fitting completion position, and is locked to the one wall surface 501b of the wall body 501 in such a fitted state, and is used to hold the housing 10 at the fitting completion position to the wall body 501 (FIGS. 1 to 3).

The holding member 40 is molded in, for example, a plate shape (FIGS. 1 to 3). Here, a metal plate molded using a metal plate as a base material is used for the holding member 40. The holding member 40 illustrated here includes a main body 41 formed in a rectangular flat plate shape and allows a fitting portion 41a on one side to be fit into the groove 11c at the distal end 11a of the fitting portion 11, and protrusions 42 formed in a rectangular flat plate shape and protruding from both ends of the fitting portion 41a of the main body 41 on the same plane (FIGS. 1 to 3). The linear groove 11c into which the fitting portion 41a is fitted is formed at the distal end 11a of the fitting portion 11 (FIG. 1).

In the terminal block 1, the holding member 40 is locked to the one wall surface 501b of the wall body 501 at the fitting completion position, and the flange 12 of the housing 10 is locked to the other wall surface 501c of the wall body 501 at the fitting completion position (FIG. 3). That is, in the terminal block 1 at the fitting completion position of the fitting portion 11 and the fitting hole 501a, the wall body 501 is sandwiched between the holding member 40 and the flange 12 of the housing 10, whereby the housing 10 is held on the wall body 501.

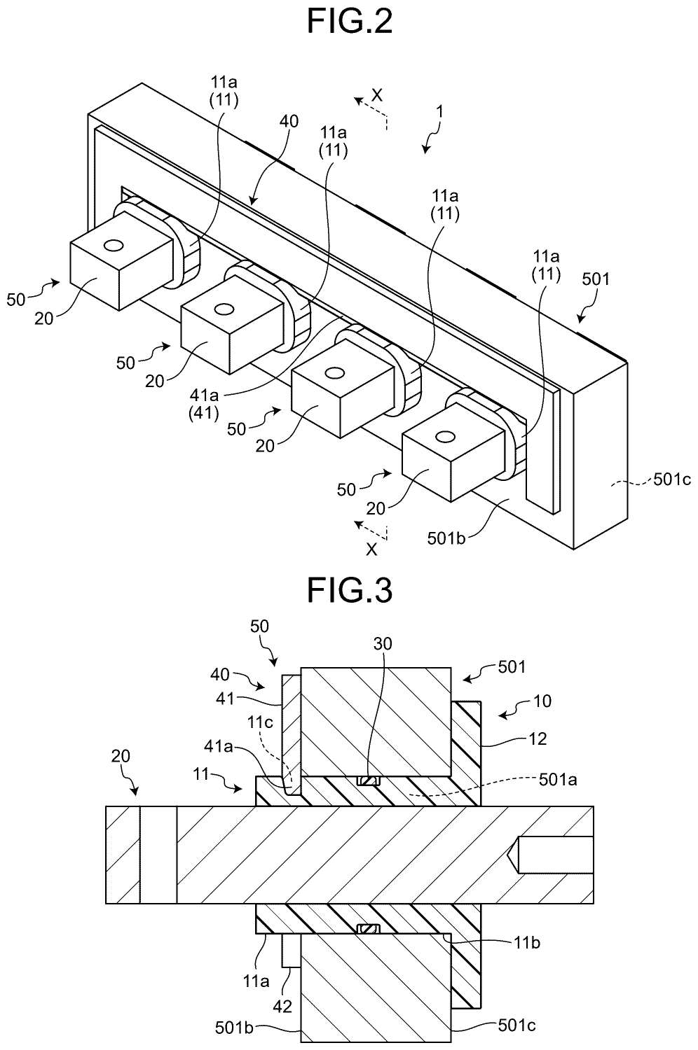

The terminal block 1 illustrated here includes a plurality of terminal components 50 each including the housing 10, the electrical connection member 20, and the seal member 30 combined one by one (FIGS. 1 and 2). Here, four terminal components 50 are provided. The plurality of terminal components 50 are respectively inserted and fitted into the fitting holes 501a for the terminal components 50 arranged in a row in the wall body 501 for the respective terminal components 50, and the distal ends 11a of the fitting portions 11 protrude from the fitting holes 501a.

The holding member 40 may hold each of the terminal components 50, or may collectively hold the plurality of terminal components 50. The terminal block 1 illustrated here includes one holding member 40 that collectively holds the plurality of terminal components 50 (FIGS. 1 and 2). The holding member 40 is fitted into the grooves 11c of the distal ends 11a of the fitting portions 11 in the housings 10 of the respective terminal components 50 at a fitting completion position, and is locked to the one wall surface 501b of the wall body 501 in such a fitted state to hold the respective housings 10 at the fitting completion position to the wall body 501.

In the terminal block 1 of the present embodiment, the housing 10 is assembled to the wall body 501 by inserting and fitting the fitting portion 11 into the fitting hole 501a of the wall body 501. In the terminal block 1, the housing 10 is held on the wall body 501 by fitting the holding member 40 into the groove 11c of the distal end 11a of the fitting portion 11 protruding from the fitting hole 501a. When the terminal block 1 includes the plurality of terminal components 50, a similar assembling work mode is adopted. In this manner, in the terminal block 1 of the present embodiment, the housing 10 can be held on the wall body 501 only by fitting the holding member 40 without requiring fastening work of a screw member as in a conventional case, and thus an assembling work time with respect to the wall body 501 can be shortened.

In addition, a conventional terminal block requires a tool such as an impact wrench for fastening the screw member. However, in the terminal block 1 of the present embodiment, the holding member 40 can be manually fitted without using a tool as long as a worker manually performs assembly to the wall body 501.

In addition, in the conventional terminal block, a collar member through which a male screw portion is inserted is provided in the housing in addition to the screw member. However, since the terminal block 1 of the present embodiment does not need to use such a screw member or a collar member, the number of components can be reduced. Furthermore, the terminal block 1 of the present embodiment does not require insert molding of a housing in which the collar member is placed in a mold, and thus the mold can be simplified. Due to these advantages, the terminal block 1 of the present embodiment can reduce cost as compared with the conventional case adopting a screwing structure.

In a terminal block according to the present embodiment, a housing is assembled to a wall body by inserting and fitting a fitting portion into a fitting hole of the wall body. Then, in the terminal block, the housing is held on the wall body by fitting a holding member into a groove at a distal end of the fitting portion protruding from the fitting hole. In this manner, in the terminal block according to the present embodiment, it is possible to hold the housing on the wall body only by fitting the holding member without requiring fastening work of a screw member as in a conventional case, and thus, it is possible to shorten an assembling work time with respect to the wall body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing including a fitting portion that is inserted and fitted into a fitting hole having a through-hole shape of a wall body of an object to be assembled from a distal end and allows the distal end to protrude from one wall surface of the wall body at a fitting completion position with respect to the fitting hole;
an electrical connection member housed in the housing and responsible for electrical connection with a counterpart; and
a holding member that holds the housing on the wall body at the fitting completion position, wherein
the holding member is fitted into a groove at the distal end of the fitting portion at the fitting completion position and is locked to the one wall surface of the wall body in a fitted state to hold the housing at the fitting completion position on the wall body.

2. The terminal block according to claim 1, further comprising:
a plurality of terminal components in which the housing and the electrical connection member are combined one by one, wherein
the plurality of terminal components are respectively inserted and fitted into the fitting holes for the terminal components arranged in a row in the wall body for the respective terminal components, and the distal ends protrude from the fitting holes, and
the holding member is fitted into the groove at the distal end of the fitting portion in the housing of each of the terminal components at the fitting completion position and is locked to the one wall surface of the wall body in a fitted state to hold each of the housings at the fitting completion position on the wall body.

3. The terminal block according to claim 1, wherein
the holding member is molded in a plate shape.

4. The terminal block according to claim 2, wherein
the holding member is molded in a plate shape.

5. The terminal block according to claim 1, wherein
the housing includes a flange provided at a rear end of the fitting portion and locked to another wall surface of the wall body at the fitting completion position.

6. The terminal block according to claim 2, wherein
the housing includes a flange provided at a rear end of the fitting portion and locked to another wall surface of the wall body at the fitting completion position.
